(19) United States
(12) Patent Application Publication
(10) Pub. No.: US 2009/0144703 A1
(43) Pub. Date: Jun. 4, 2009

(54) Method and system for versioning a software system

(76) Inventors: Vallieswaran Vairavan, Chennai (IN); Umesh Bellur, (US)

Correspondence Address: LOUIS VENTRE, JR, 2483 OAKTON HILLS DRIVE, OAKTON, VA, 22124-1530, US

(21) Appl. No.: 12/324,950

(22) Filed: Nov. 28, 2008

(30) Foreign Application Priority Data
Nov. 30, 2007 (IN) 2822/CHE/2007

(51) Int. Cl. G06F 9/44

(52) U.S. Cl. 717/122

(57) ABSTRACT

A versioning system and a versioning scheme verify compatibility between a plurality of entities. The versioning scheme comprises two version numbers—model version number and code version number. Model version number and code version number of each entity is maintained to determine the compatibility between a plurality of entities at the design level and the source code level. A layered structure of a software configuration management tool handles the versioning scheme of the plurality of entities.

### TECHNICAL FIELD

In the field of software development, a method and system are disclosed for versioning of design diagrams and source code during software development.

### BACKGROUND ART

Definitions of terms as used herein follow.

Software Configuration Management (SCM): a system for tracking and controlling changes made to software during the course of software development. It is used to develop, document and store different versions of all the components that are used to build the software.

Sequence Diagram: A sequence diagram is an interaction diagram in UML, and shows how processes operate with each other and in what order.

Unified modeling language (UML): UML is a standardized modeling language in the field of software system development. UML includes a set of graphical notation techniques to create abstract models of specific software systems.

XMI: The XML Metadata Interchange (XMI) is used for exchanging metadata information via extensible markup language (XML). XMI is most commonly used as an interchange format for UML models and it can also be used for serialization of models of other languages.

Object: In the programming languages considered herein, an object is created as an instance of a class. An object may contain data, instructions operating on the data or both.

Association: Association refers to a bidirectional connection between two entities. Wherein entities include but are not limited to objects, components, and the likes.

Generalization: Generalization refers to a unidirectional inheritance relationship that associates two or more instances, wherein one instance is a sub-type of another instance (super-type). The instance belonging to the sub-type may be substituted for the instance belonging to the super-type.

State machine: The term state machine refers to the behavior of collaboration, specified as a collection of actions carried out over a sequence of state changes.

Software development is an iterative process. An existing software system undergoes a plurality of iterations for subsequent improvements. Programmers create abstract models of software using a software modeling language, wherein these abstract models are referred to as designs of the software. A source code is then developed to implement the designs of the software. The source code and the designs of the software together comprise the software system. The designs are visual and at a higher level of abstraction than the source code. Hence, any change made to the designs is easier to comprehend than a corresponding change to the source code. This makes the designs an important tool for evolving and improving the software system.

Unified Modeling Language (UML) is a standardized software modeling language. UML uses graphical notation to create the designs of the software. The designs of the software comprise a plurality of design diagrams, each design diagram being a partial graphical representation of a particular design. The plurality of design diagrams include: structure diagrams, behavior diagrams and interaction diagrams. The design diagrams along with subsequent entities in the design diagrams together comprise design entities of the software.

In the course of evolution of the software system, there may be more than one version of source code for implementing a particular design. Furthermore, there may be improvements in the designs of the software resulting in more than one version of a particular design of the software.

FIG. 1 is a block diagram depicting the evolution of design and source code of software during the course of software development. A software development project typically starts the development phase with Design version-0 102 that is the prototype for the design of the software system. Coding is done corresponding to Design version-0 102 to generate Code version-0 104. While developing the source code, the design may need to be altered resulting in Design version-1 106. In the meanwhile, the source code files might progress a few versions from Code version-0 104 to Code version-3 108 and subsequently to Code version-6 110. This makes a functional system. Now, re-factoring and performance improvement is done by analyzing Design version-1 106. As a result of the refactoring, Design version-2 112 is obtained. Now, source code files need to be changed which results in Code version-7 114. Each source code version comprises a plurality of source code modules and each design version comprises a plurality of design diagrams. There are several individuals involved in the creation and development of the plurality of design diagrams and the plurality of source code modules. Since several individuals may be involved in the development of the software system at the same time, a versioning scheme is required to manage the plurality of design diagrams and the plurality of source code modules.

Patent JP2047718 titled, “Design information version management system” discloses a method of versioning of a plurality of design items. The history of design information of each item is stored in a design information database. The design information of each item can be extracted based on the selective instruction from a user. The design information of the items edited by the user is compared with that of the corresponding extracted items. The design information of the items edited by the user are then stored in the design information database to update design information.

Patent GB2428321A titled, “Versioning objects in a virtual machine” discloses a method for managing versioning data for objects in a virtual machine. A request to allocate an object is received, wherein the request identities a plurality of parameters for classifying the object. An entry for the object is created in a versioning data structure using the plurality of parameters received in the request. The versioning data structure is used to store delta data for change in the data. When a change in the data for the object occurs, the delta data is stored in the versioning data structure based on the plurality of parameters. A particular version of the object may be retrieved using the plurality of parameters.

Although, the abovementioned prior arts could be implemented for storing different versions of design entities and source code, storing changes between their versions and retrieving their previous versions but they fail to determine the compatibility between the plurality of design entities and source code modules. In the absence of a versioning system which determines the compatibility between the plurality of design entities and source code modules, the lifecycle processes like testing and deployment during the software development are delayed.

Hence, there is a need for a versioning system that is able to identify the compatibility between a plurality of design entities and source code modules to speed up the lifecycle processes during the software development.

### SUMMARY OF INVENTION

The present invention discloses a relational meta-model of a software system created to represent entities of the software system in a plurality of perspectives. The relational meta-model also displays relationships between the plurality of perspectives. In another embodiment of the invention, a relational meta-model of the software system is created representing a plurality of perspectives and the relationships between the plurality of perspectives, the software system being created in an aspect oriented programming environment.

The present invention discloses a system for versioning of a new entity, the system comprising a user interface to receive a new entity, a repository to check in the new entity and store different version of the entities and a versioning system to assign version numbers to the new entity.

The present invention discloses a versioning scheme in which two version numbers—model version number and code version number of each entity is maintained to determine the compatibility between a plurality of entities at the design level and the source code level.

In an embodiment of the invention, a layered structure of a software configuration management tool is disclosed to handle the versioning scheme of the plurality of entities

### BRIEF DESCRIPTION OF DRAWINGS

FIG. 1 is a block diagram depicting the evolution of design and source code of software during the course of software development.

FIG. 2 is a schematic representing relational meta-model of a software system in accordance with an embodiment of the present invention.

FIG. 3 is a detailed schematic representing relationship between deployment perspective diagram, requirements perspective diagram and development perspective diagram in accordance with an embodiment of the present invention.

FIG. 4 is a detailed schematic representing relationship between development perspective diagram and source perspective diagram in accordance with an embodiment of the present invention.

FIG. 5 is a detailed schematic representing relationship between deployment perspective diagram, requirements perspective diagram, development perspective diagram and source perspective diagram of a software system developed in an aspect oriented programming environment in accordance with an embodiment of the present invention.

FIG. 6 is a schematic representing software system development environment in accordance with an embodiment of the present invention.

FIG. 7 is a schematic representing in detail a versioning module in accordance with an embodiment of the present invention.

FIG. 8 is a schematic representing an entity in a relational meta-model in accordance with an embodiment of the present invention.

FIG. 9 is a flowchart depicting the steps involved in versioning of the entity of the software system in accordance with an embodiment of the present invention;

FIG. 10 is a flowchart depicting the steps involved in assignment of a value to the file version number associated with the entity in accordance with an embodiment of the present invention. And,

FIG. 11 is a schematic depicting layered model of SCM for implementing the versioning of entities in accordance with an embodiment of the present invention.

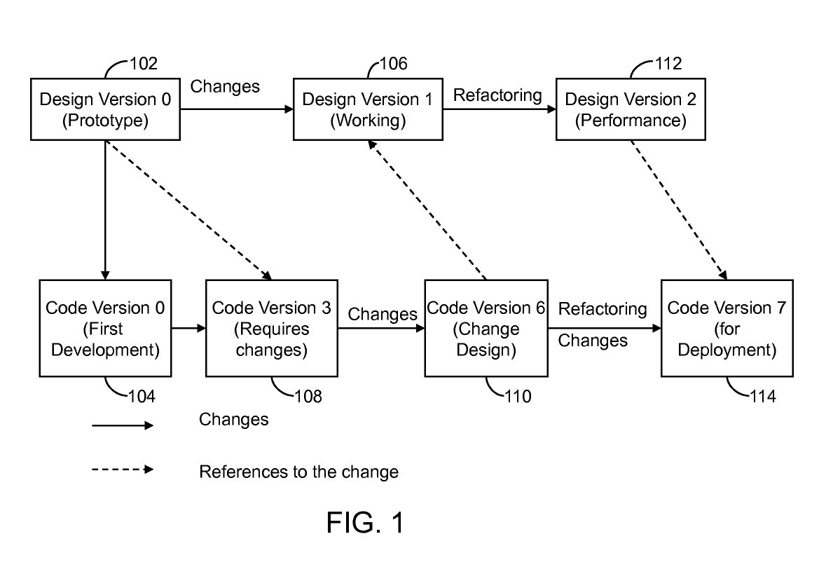

### DESCRIPTION OF EMBODIMENTS

In the following description, for the purposes of explanation, specific details are set forth in order to provide a thorough understanding of the invention. However, it will be apparent that the invention may be practiced without these specific details. Various aspects and features of example embodiments of the invention are described in more detail hereinafter.

An embodiment of the present invention or any of its components may be embodied in the form of a processing machine. Typical examples of a processing machine include a computer, a programmed microprocessor, an integrated circuit, and other devices or arrangements of devices that are capable of implementing the steps of the method of the current invention. The processing machine executes a set of instructions that are stored in one or more storage elements, in order to process input data. The storage elements may also hold data or other information as desired. The storage element may be in the form of an information destination or a physical memory element present in the processing machine. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the internet or any client server models that enable communication. Such communication technologies may use various protocols such as TCP/IP, UDP, ATM or OSI.

A relational meta-model is created to represent design diagrams and relationships between the design diagrams. The relational meta-model also comprises a representation of the source code modules of the software and relationships between the source code modules and the design diagrams. The representation of the design diagrams and the source code modules and the relationships between them would facilitate the versioning of the design diagrams and the source code modules and determination of compatibility between different versions of design diagrams and source code modules.

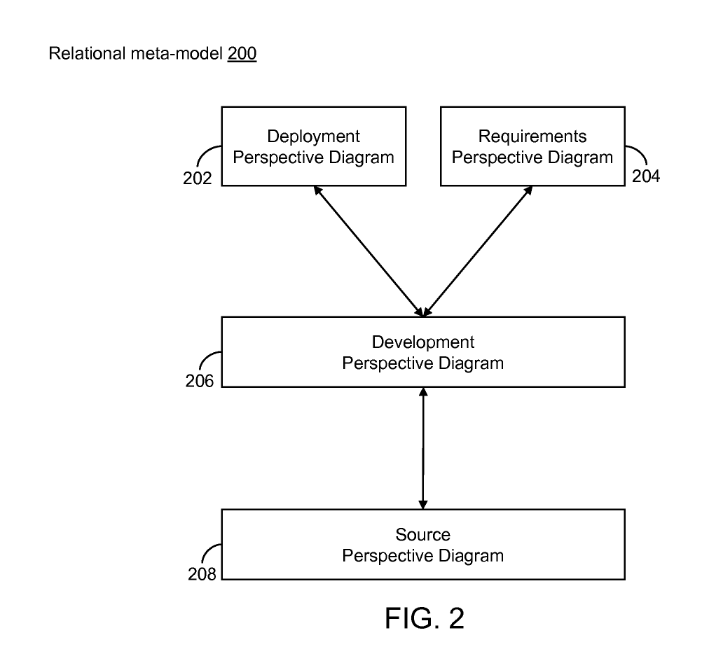

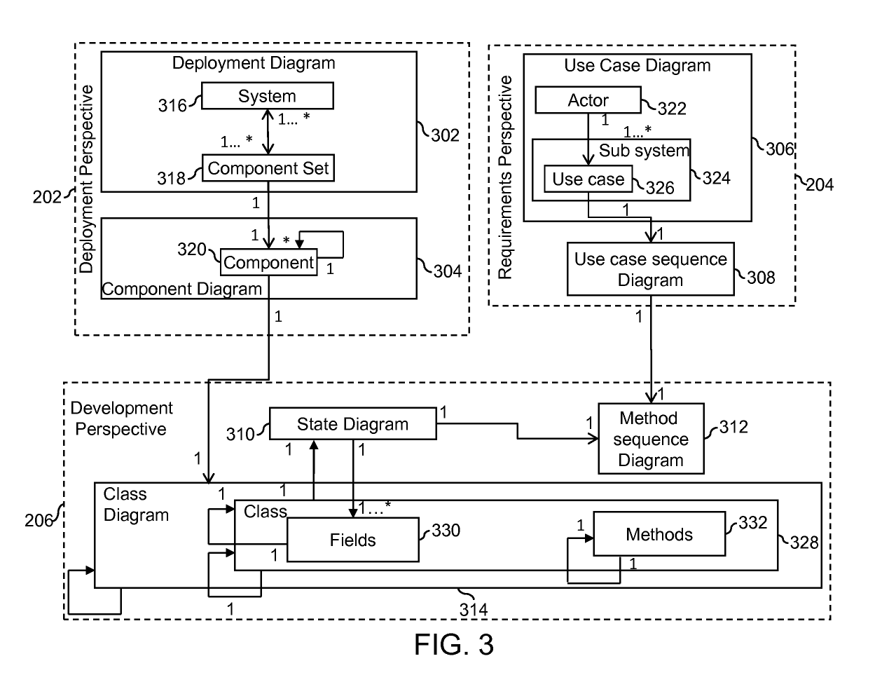

FIG. 2 is a schematic representing relational meta-mode of a software system during software system development in accordance with an embodiment of the present invention. The relational meta-model comprises a plurality of design diagrams and displays relationships between the design diagrams. Further, relational meta-model includes deployment perspective diagram 202, requirements perspective diagram 204, development perspective diagram 206 and source perspective diagram 208. Deployment perspective diagram 202 represents deployment details of the software system and is used to generate builds of the software system from source code. Builds of the software system refers to at least one software artifact that can be run on a computer obtained as a result of converting source code into executable code after compilation. Deployment perspective diagram 202 is used by software configuration management tools. Requirements perspective diagram 204 represents a plurality of requirements of the software system. The requirements of a system comprise, but are not limited to actors, use cases and use case sequences. Actors, use cases and use case sequences are explained in further detail in conjunction with FIG. 3. Development perspective diagram 206 represents designs of the software. The designs of the software are abstract models of the software, created by programmers, using a software modeling language. Development perspective diagram 206 is directly related to deployment perspective diagram 202, requirements perspective diagram 204 and source perspective diagram 208. Source perspective diagram 208 represents source code of the software system. Source perspective diagram 208 has a bi-directional relationship with development perspective 206.

Deployment perspective diagram 202, requirements perspective diagram 204 and development perspective diagram 206 comprise a plurality of design entities and source perspective diagram 208 comprises at least one code entity. Herein, an entity refers to either of a design entity or a code entity. The design entities and the code entities may be prepared in UML (unified modeling language) format. In an embodiment of the invention, the design entities and the code entities are converted to XMI format. In another embodiment, the design entities and the one code entity may be prepared in XMI format. In XMI, each entity is represented as XMI tree structure. The XMI tree structure for the design entities is explained in further detail in conjunction with FIG. 3

FIG. 3 is a detailed schematic representing relationship between deployment perspective diagram 202, requirements perspective diagram 204 and development perspective diagram 206 in accordance with an embodiment of the present invention. Deployment perspective diagram 202, requirements perspective diagram 204 and development perspective diagram 206 comprise a plurality of design entities.

A plurality of links between the entities represents the relationship between deployment perspective diagram 202, requirements perspective diagram 204 and development perspective diagram 206. 1 and 1 . . . * denote the multiplicity of the entities at the ends of a link. 1 denotes a single design entity and 1 . . . * denotes a plurality of entities. For example, suppose a link between two entities starts with 1 and ends with 1 . . . *, it denotes a one-to-many relationship. A one-to-many relationship denotes a link between one entity and a plurality of other entities. Suppose a link between two entities starts with 1 and ends with 1, it denotes a one-to-one relationship. A one-to-one relationship denotes a link between two single entities.

Deployment perspective diagram 202 includes deployment diagram 302 and component diagram 304. Deployment diagram 302 comprises system 316 and component set 318. Component diagram 304 comprises at least one component 320. Component 320 is a component of the software which is ready for deployment. In an embodiment of the invention, the XMI tree structure of component diagram 304 is:
UML: Component set (Defines)
   UML: components (Defines)+
   UML: component Association (Defines)*
   UML: Class set (refers)

Wherein UML refers to the inter-convertibility of the structure of a particular entity in XMI to a corresponding structure of the entity in UML, wherein “defines” outlines the structure of a particular entity and “refers” denotes at least one entity referred to by the particular entity. In an embodiment of the invention, default type of “defines” is creates which denotes creation 830. In another embodiment of the invention, default type of “refers” is read 834. Creation 830 and read 834 are described in detail in conjunction with FIG. 6. For example, in the XMI tree structure of component diagram 304, UML: Component Set (Defines) denotes that the structure of component diagram 304 could be converted to a corresponding structure in UML. Further, the structure of component diagram 304 comprises at least one component 320. Component 320 may be associated to another component, wherein the association refers to a set of classes.

Requirements perspective 204 includes use case diagram 306 and use sequence diagram 308. Use case diagram 306 comprises actor 322 and subsystem 324. Sub system 324 further comprises use case 326. Development perspective 206 includes state diagram 310, method sequence diagram 312 and class diagram 314. Class diagram 314 includes at least one class 328. Class 328 further comprises fields 330 and methods 332.

Deployment diagram 302 refers to component diagram 304 for component 320. Component diagram 304 comprises component 320 and describes properties of component 320. In an embodiment of the invention, the XMI tree structure of deployment diagram 302 is:
UML: System (Refers)+
   UML: Component set (Refers)+

Component 320 in component diagram 304 is linked to class diagram 314 in development perspective 206. Class diagram 314 comprises at least one class 328. Class 328 comprises fields 330 and methods 332. Fields 330 comprises definitions of a plurality of instances of class 328. Method 332 comprises a sequence of statements to perform an action, a set of inputs to customize the action and an output value of the action. Class 328 describes the source for component 320. The build of the software generated from deployment diagram 302 is based on the relations between class 328 and component 320. Deployment perspective diagram 202 is used by configuration management tools.

The plurality of components 320 in component diagram 304 is inter-related. Deployment diagram 302 displays configuration of executable codes of the software system, a plurality of processes and entities of the software system. The configuration of executable codes, processes and entities of the software system comprises data which has to be taken as an input from an external system to execute the executable codes, processes and entities of the software system. System 316 describes physical system required for development and execution of the software system.

Requirements Perspective diagram 204 comprises use case diagram 306 and use case sequence diagram 308. Use case diagram 306 typically contains one or more use case 326. Use case 326 describes the interaction between an actor 322 and the software system itself, represented as a sequence of steps. Actor 322 provides stimulus to the software system and is defined as being outside the software system. Examples of actor 322 include but are not limited to, end users, other software systems and hardware devices. Use case 326 is linked to use case sequence diagram 308. Use case sequence diagram 308 describes sequence diagram of at least one use case 326. The collaborations between a plurality of use cases 326 and the sequence in which they are implemented are described by use case sequence diagram 308. In an embodiment of the invention, the XMI tree structure for use case diagram 306 is:
UML: Use_Case(Defines)
   UML: SubSystem (Defines)+
      UML: Use-cases (Defines)+
      UML: actionsequence type: Use case (Refers)
      UML: Association (Defines)*
         UML: Use cases (Refers)/UML: Actor (Refers)
      UML: generalization (Defines)*
         UML: Use cases (Refers)
UML: Actor (Defines)+
   UML: Association (Defines)+
      UML: Use cases(Refers)

Use case sequence diagram 308 refers to method sequence diagram 312 of development perspective diagram 206. In an embodiment of the invention, the XMI tree structure for use case sequence diagram 308 is:
UML: actionsequence type: Use case (Defines)
   UML: actionsequence type: method (Refers)
   UML: SubSystem Instance (Defines)*
      UML: SubSystem (Refers)
   UML: Class Instance (Defines)*
      UML: class (Refers)

Method sequence diagram 312 details the execution of method 332 in terms of dependencies on class 328 for realization of method 332. In an embodiment of the invention, the XMI tree structure for method sequence diagram 312 is:
UML: Action sequence type: method (Defines)
UML: Class (Refers)
   UML: Method (Refers)
   UML: Instance (Defines reference definition/Creates)+
      UML: Class (Refers)
         UML: State (Refers)
UML: Message (Defines)*
   UML: Instance sender (Refers Read/Write)
   UML: Instance receiver (Refers Read/Write)
   UML: Methods (Refers)

Wherein “defines” comprises creation 830 and reference definition 832; “refers” comprises read 834 and write 836. Reference definition 832 and write 836 are described in detail in conjunction with FIG. 6.

Development Perspective diagram 206 represents the design of the software system. Class diagram 314 comprises at least one class 328. Class 328 is associated with state diagram 310 and comprises at least one method 332. In an embodiment of the invention, the XMI tree structure of class diagram 314 is:
UML: Class Set (Defines)
   UML: class (Defines)+
      UML: Association (Defines)+
         UML; class (Refers)
      UML: Attributes (Defines)*
      UML: Methods (Defines)*
         UML: actionsequence type: method (refers)
      UML: State_Machines (Refers)

Wherein attributes are definitions of plurality of objects of class 328, actionsequence type denotes the sequence in which a plurality of method 332 is called in class 328.

State diagram 310 utilizes method sequence diagram 312 for state transitions. State diagram 310 comprises but is not limited to states, transitions, activities, events and the like which are used to describe dynamics of the software system. State diagram 310 comprises a plurality of states of the plurality of design entities of the software system including but not limited to activation, deactivation, initialization and events of the plurality of design entities. State diagram 310 displays sequences of states which the plurality of design entities go through during lifetime in response to received input, together with transitions and actions that the plurality of design entities undergo. In an embodiment of the invention, the XMI tree structure of state diagram 310 is:
UML: State_Machines (Defines)
   UML: State (Defines)+
      UML: Attributes (Refers)+
      UML: Message (defines)*
         UML: State type: destination (Refers)
         UML: method (Refers)

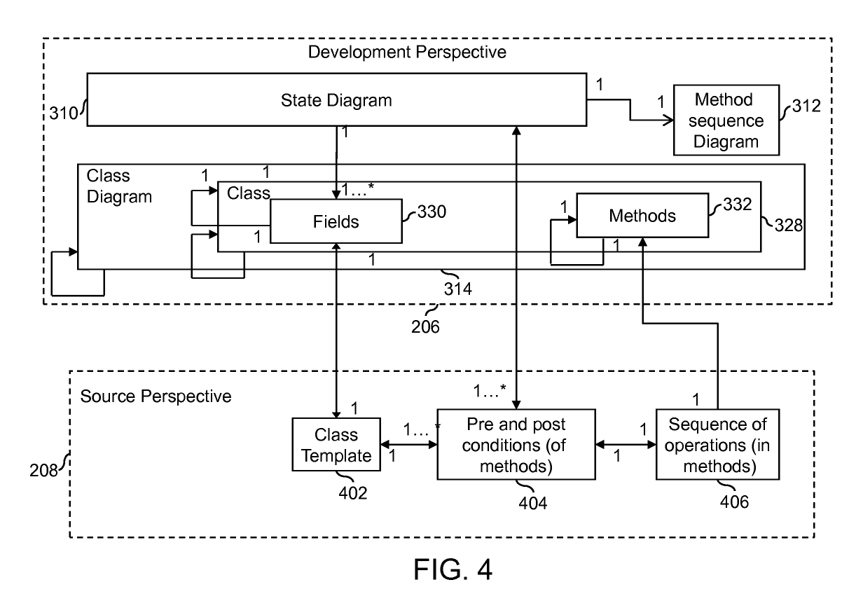

Development perspective diagram 206 has bi-directional relation with source perspective 208. The bi-directional relationship between development perspective 206 and source perspective 208 is described in conjunction with FIG. 4.

FIG. 4 is a detailed schematic representing relationship between development perspective diagram 206 and source perspective diagram 208 in accordance with an embodiment of the present invention. Source perspective diagram 208 represents the source code of the software system and comprises of at least one code entity. Source perspective diagram 208 includes class template 402, pre and post conditions 404 and sequence of operations 406. Class template 402, pre and post conditions 404 and sequence of operations 406 are code entities of source perspective diagram 208. Class diagram 314 in development perspective diagram 206 is converted to class template 402 in source perspective diagram 208. State diagram 310 can be converted to pre-conditions and post-conditions 404 for method 332 of class 328. Method sequence diagram 312 can be converted to sequence of operations 406. The consistency is maintained by utilizing state diagram 310, method sequence diagram 312 and class diagram 314 for source code generation. Pre and post conditions 404 ensure that state diagram 310 is consistent with properties of state diagram 310. Source perspective diagram 208 is specific to programming language. For example, in java state transition violations can be implemented by exceptions and report to user via exception handler. The relations between the source code and the designs are bi-directional since both are entities used in the development of the software. The source code can be considered to be an entity in programming language specific format and the design can be considered to be an entity in a modeling language specific format. Development environments, compilers and interpreters use source perspective 208 diagram.

Certain entities, as described herein have been appended to requirements perspective diagram 204, development perspective diagram 206 and source perspective diagram 208 to create a relational meta-model of a software system developed in an aspect oriented programming environment.

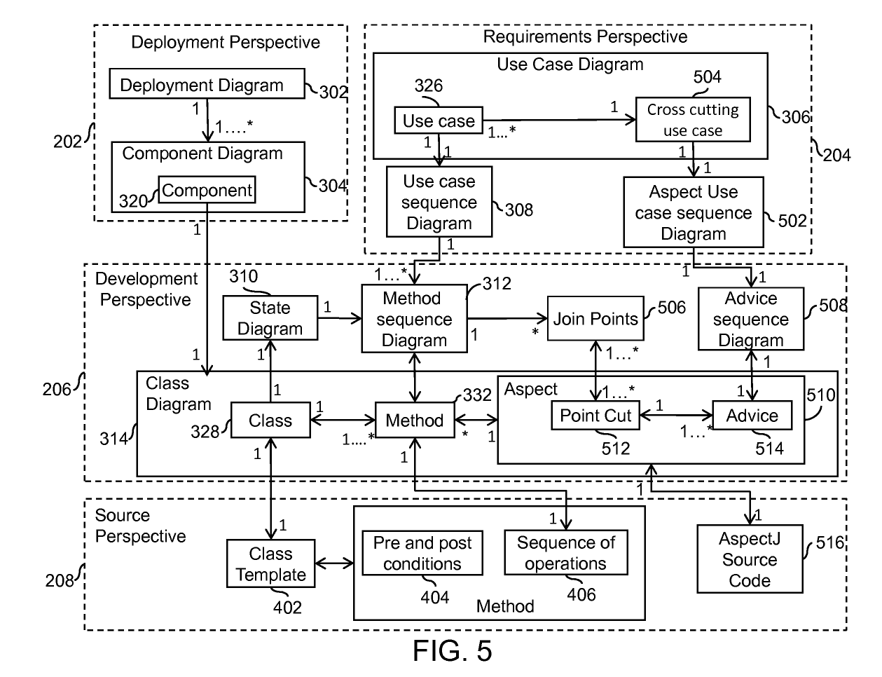

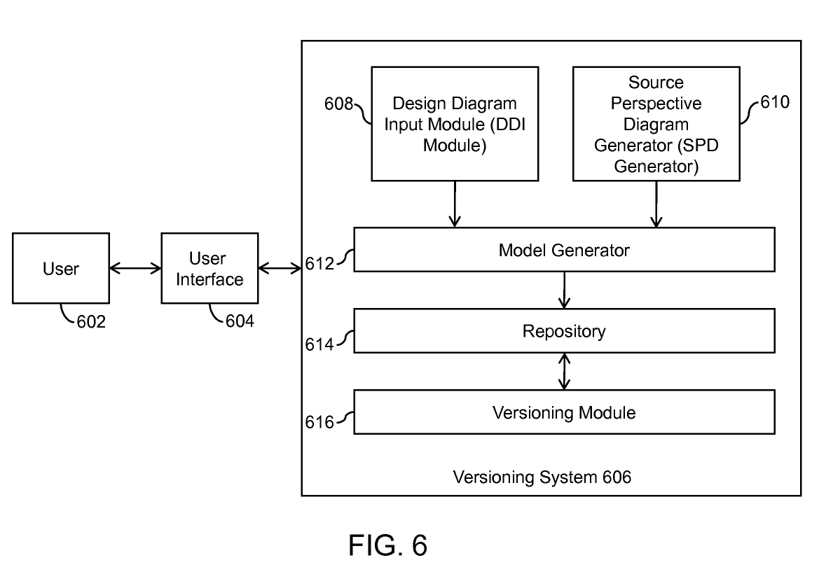

FIG. 5 is a detailed schematic representing relationship between deployment perspective diagram 202, requirements perspective diagram 204 and development perspective diagram 206 and source perspective diagram 208 of a software system developed in an aspect oriented programming environment in accordance with an embodiment of the present invention.

Deployment perspective diagram 202 comprises deployment diagram 302 and component diagram 304 as described earlier in conjunction with FIG. 3.

Requirements perspective diagram 204 comprises use case diagram 306, use case sequence diagram 308 and aspect use case sequence diagram 502. Use case diagram 306 further comprises use case 326 and cross cutting use case 504. Use case 326 may have at least one cross cutting concern. The source code of any software system has a plurality of functionalities. Each of these functionalities is called a concern. However, there are some concerns that have to be used in more than one of the concerns. These concerns are called cross cutting concerns. Logging is an example of a cross cutting concern because logging necessarily affects every single logged part of the software system. Logging thereby crosscuts each logged class 328 and method 332. Cross cutting use case 504 represents the cross cutting concerns. Aspect use case sequence diagram 502 represents sequence of method 332 in cross cutting use case 504, wherein aspect use case diagram 502 is linked to method 332 via advice sequence diagram 508 and class 328 respectively.

Development perspective diagram 206 comprises state diagram 310, method sequence diagram 312, class diagram 314, join points 506 and advice sequence diagram 508. Class diagram 314 further comprises class 328, method 332 and aspect 510. Aspect 510 further comprises point cut 512 and advices 514. Point cut 512 comprises a set of join points 506. Join points 506 comprise points in the source code where the cross cutting concerns are implemented in the source code. Advice 514 describes a class of functions which modify other functions when the latter are run. Advice 514 is applied at join points 506 of the source code. Advice sequence diagram 508 defines the sequence of execution of advice 514 in the source code at join points 506.

Source perspective diagram 208 comprises class template 402, pre and post conditions 404, sequence of operations 406 and aspectJ source code 516. AspectJ source code 516 describes point cut definitions and advice definitions from aspect 510 in class diagram 314. AspectJ source code 516 further comprises advice code from advice sequence diagram 508.

FIG. 6 is a schematic representing software system development environment, in accordance with an embodiment of the invention. Software system development environment includes user 602, user interface 604 and versioning system 606. User 602 interacts with versioning system 606 through user interface 604. Versioning system 606 assigns version numbers to the plurality of design entities and code entities developed by user 602. In an embodiment of the invention, versioning system 606 is run on a computer system comprising Microsoft windows server 2003 as operating system, 1 Quad Core Intel Xeon L5420 processor, 2 GB installed RAM (fully buffered DIMMS) and 2×73 GB SAS SFF 2.5″ Drives (RAID).

Versioning system 606 includes design diagram input (DDI) module 608, source perspective diagram (SPD) generator 610, model generator 612, repository 614 and versioning module 616. DDI module 608 receives the design diagrams of the software, from user 602 through user interface 604. In an embodiment of the invention, the design diagrams received by DDI module 608 are in UML format and are converted to XMI format by DDI module 608. In another embodiment of the invention, the design diagrams received by DDI module 608 are in XMI format. SPD generator 610 receives the source code of the software, developed by user 602 from user interface 604. Thereafter, SPD generator 610 converts the source code of the software to source perspective diagram 208.

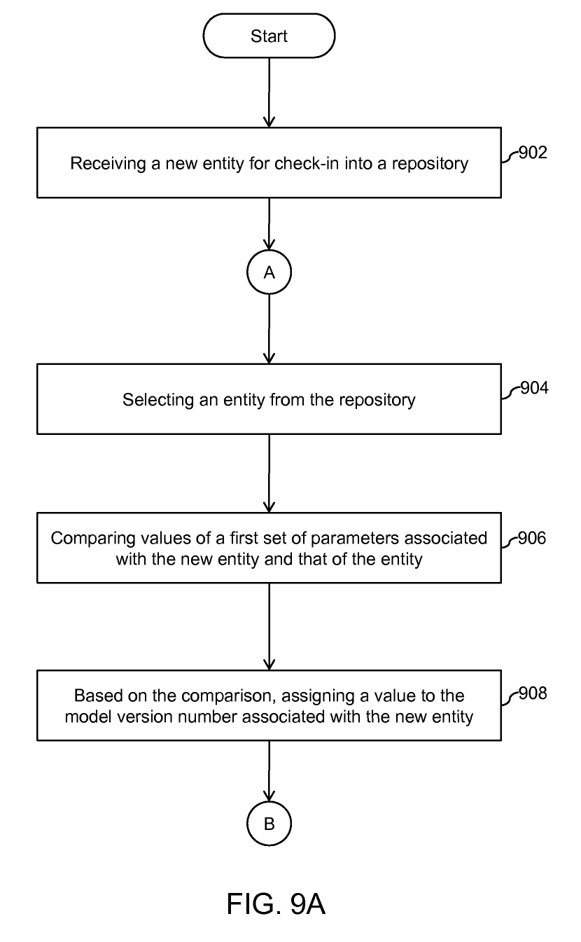

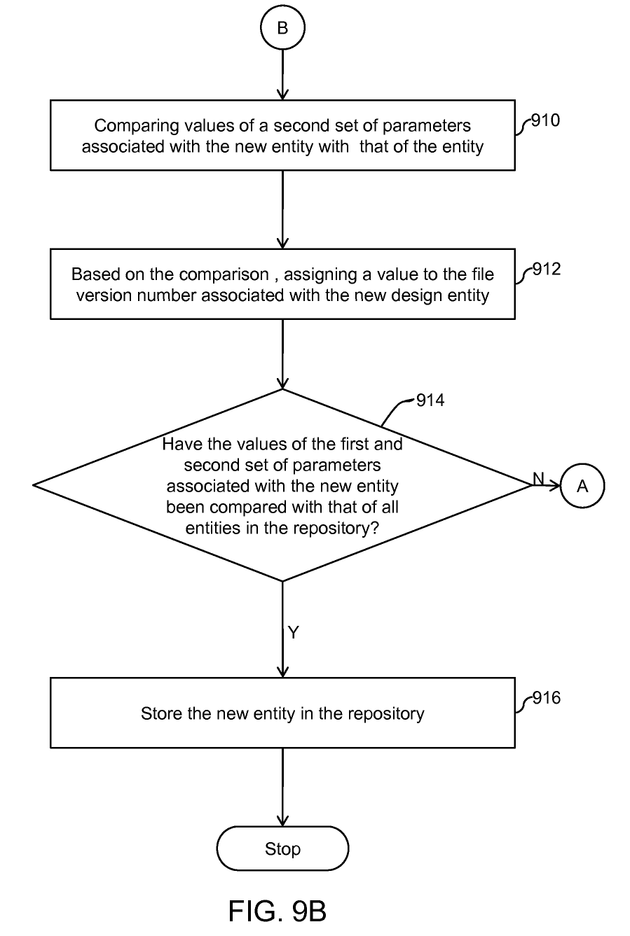

Model generator 612 receives the design diagrams in XMI format from DDI module 608 and source perspective diagram 208 from SPD generator 610. Thereafter, model generator 612 links entities based on relationships between the entities as specified by user 602 in order to generate the relational meta-model. The entities are entered into repository 614. Repository 614 is storage medium for storing the entity and all the versions of the entity. In case a new entity is created by user 602, it is stored in repository 614. For any subsequent changes to be made to the entity, user 602 checks out the entity from repository 614. After the changes have been made, the entity is checked into repository 614. Versioning of the entity is carried out by versioning module 616. Steps involved in versioning of the entity are explained in further detail in conjunction with FIG. 9. Thereafter, the entity is stored in repository 614.

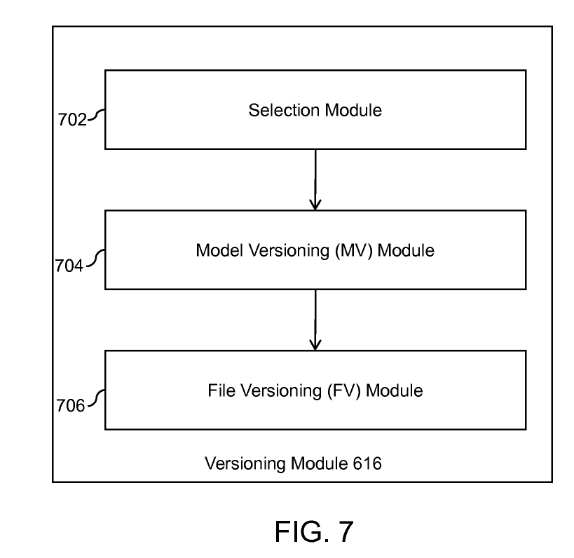

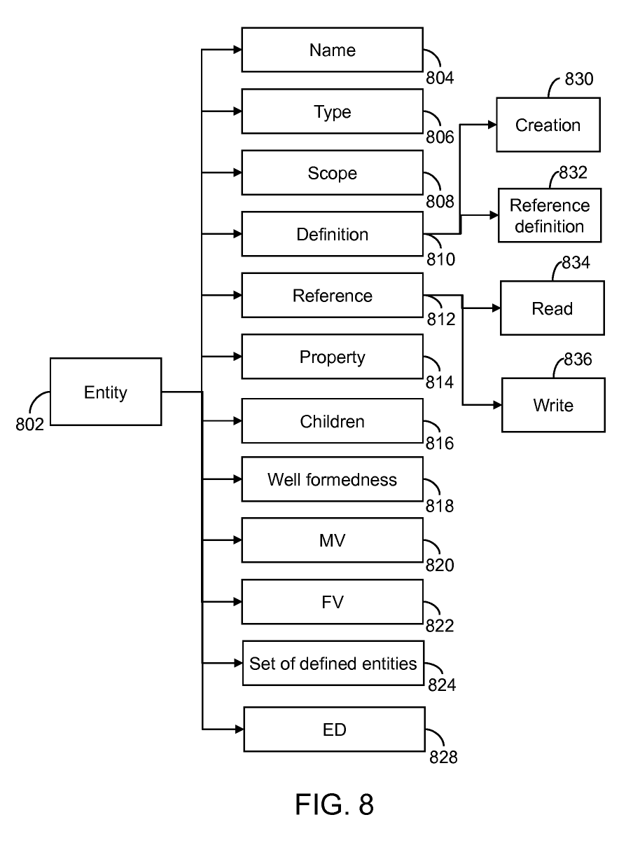

FIG. 7 is a schematic representing in detail versioning module 616 in accordance with an embodiment of the present invention. Versioning module 616 carries out the versioning of an entity which has been checked into repository 614. Versioning module 616 includes selection module 702, model versioning (MV) module 704 and file versioning (FV) module 706. Selection module 702 selects an entity A from repository 614 based on a condition. The condition for selection of the entity A is described in detail in conjunction with FIG. 9. Thereafter, selection module 702 transfers the entity A to MV module 704. MV module 704 compares values of the first set of parameters associated with the entity with the first set of parameters associated with the entity A. Based on the comparison, MV module 704 assigns model version number to the entity. Assigning the model version number to the entity is further described in detail in conjunction with FIG. 9. Thereafter, MV module 704 transfers the entity A to FV module 706. FV module 706 compares values of a second set of parameters associated with the entity with the values of the second set of parameters associated with the entity A. The second set of parameters is described in detail with conjunction to FIG. 9. Based on the comparison, FV module 706 assigns file version number to the entity.

FIG. 8 is a schematic representing entity 802 in a relational meta-model in accordance with an embodiment of the present invention. Entity 802 includes design entities and code entities. Entity 802 is associated with a set of parameters including but not limited to name 804, type 806, scope 808, definition 810, reference 812, property 814, children 816, well formedness 818, MV 820, FV 822, set of defined entities 824 and ED 828. Definition 810 has a plurality of parameters including but not limited to creation 830 and reference definition 832. Further, reference 812 has a plurality of parameters including but not limited to read 834 and write 836.

Name 804 denotes the name assigned to entity 802 during software system development. Type 806 denotes the type of entity 802. Design entity, code entity and the like are types of entity 802. Scope 808 describes level of accessibility of entity 802. For example, suppose the level of accessibility associated with entity 802, which is defined in class 328, is private, entity 802 can be used only within class 328. In case, the level of accessibility associated with entity 802 is public, entity 802 can be used by a plurality of classes 328.

Definition 810 comprises creation 830 and reference definition 832. Creation 830 is a list of children entities, wherein the children entities are the entities contained in entity 802. In another embodiment of the invention, the children entities in entity 802 are stored as XMI tree structure. Reference definition 832 comprises a set of XML tags created to define structure, property, relationships and the likes of entity 802.

Reference 812 is the set of referred entities which are referred to by a particular entity 802. Read 834 is a set of entities referred to by entity 802 through read reference wherein the read reference copies the values of the set of entities to entity 802. Write 836 is a set of entities referred to by entity 802 through write reference, wherein write reference changes the values of the set of entities referred to by entity 802. Property 814 comprises a list of properties of entity 802, such as user permissions, modified access data and the like.

Children 816 comprises list of children entities of entity 802 and a plurality of parameters associated with the children entities of entity 802. The plurality of parameters associated with the children entities of entity 802 include but are not limited to, name and types. Herein, the structure of the software system is maintained in XMI format. Well formedness 818 comprises well-formedness rules for creation 830 and entity 802, wherein well-formedness rules are a set of rules used for maintaining consistency of a single entity 802.

MV 820 is model version number of entity 802. The model version number is associated with a design version with which entity 802 is compatible. FV 822 is file version number of entity 802. The file version number refers to the source code version with which entity 802 is compatible. The model version number of two entities determines if the two entities are compatible at the design level and the file version number of two entities determines if the two entities are compatible at the source code level. Therefore, the model version number and the file version number of the entities are used to determine the compatibility between a design diagram version and a source code version.

Set of defined entities 824 comprises a set of entities which refer to the entity 802 for the definition of their structure.

ED 828 comprises a set of external imports for the definition of entity 802. Examples of ED 828 include but are not limited to external libraries which are referred to for the definition of entity 802.

FIG. 9 is a flowchart depicting the steps involved in the versioning of entity 802 of the software system in accordance with an embodiment of the present invention.

A software development process includes the development of design entities and code entities. Each entity is of the form as entity 802 and is associated with a set of parameters as explained in conjunction with FIG. 8. Each entity is stored in repository 614. In the course of development of the software, user 602 may need to edit the entity. The entity is checked out of repository 614. After the entity has been edited, it is referred to as a new entity. A new entity may also be created by initializing the set of parameters associated with the entity. This created entity is also referred to as a new entity. At step 902, the new entity is received by user interface 604 for check-in into repository 614. In an embodiment of the invention, the step of checking in is based on the verification of at least one predefined rule. The at least one predefined rule may be the rules of well formedness for entity 802 as described in well formedness 818. Entity 802 will be checked in only if the well-formedness rules are verified. The well-formedness rules for a particular type of entity 802 may be different from any other type of entity 802. In an embodiment of the invention, the well-formedness rules for use case diagram 306 are:
Each actor 322 must use at least one more use case 326.
Each use case 326 must be used by at least one actor 322.
Each use case 326 must belong to system 316.
Each use case 326 must reference a use case sequence diagram 308.

In another embodiment of the invention, the well-formedness rules for use case sequence diagram 308 are:
Each instance of the general class 328 must be non-null and point to a valid class in class diagram 314.
Method sequence diagram 312 reference must not be null for each method 332 called and must point to a valid method sequence diagram 312.

In another embodiment of the invention, the well-formedness rules for method sequence diagram 312 are:
Each message must have a sender and a receiver entity 802.
Each entity 802 must be the sender or the receiver in at least one interaction.
Each entity 802 must reference a valid class diagram 314 and state diagram 310.
Each message must be an instance of method 332 for some defined class 328.
Each message must conform to the signature of method corresponding to the message.

Wherein the message refers to a function call in which an object is being called from another object. Sender and receiver are kinds of class 328. The message is created in the sender class. Receiver class receives the function call.

In another embodiment of the invention, the well-formedness rules for class diagram 314 are:
Each Class diagram 314 must have at least one class 328.
Each association must have a source and target class.
Each class 328 must have at least one method 332.

In another embodiment of the invention, the well-formedness rules for state diagram 310 are:
State diagram 310 must have one start and end state.
State diagram 310 must be related to one and only one class 328.
State must be described by one or more fields 330 of class 328.
States should not have overlap of attribute values describing state.
State change events must be done by messages corresponding to method sequence diagram 312.
Each state must be reachable from start
From each state the end state should be reachable
State diagram 310 must provide a non null reference to pre and post condition 404 of the source code corresponding to class 328

Wherein the start state refers to the initialization of an instance of class 328 and end state refers to the destruction of an instance of class 328.

In another embodiment of the invention, the well-formedness rules for component diagram 304 are:
Component diagram 304 must have at least one component 320.
Each relationship between two components 320 should have two terminating end classes. The terminating end classes are called boundary classes. The boundary classes must be a type of class 328 which must be valid in class diagram 314.

In another embodiment of the invention, the well-formedness rules for deployment diagram are:
Deployment diagram 302 must be related to component diagram 304.
Component 320 in component diagram 304 should be mapped to system 316 described in deployment diagram 302.

The source code comprises a plurality of source code files which further comprise a plurality of classes, the plurality of source code files are combined to prepare the source code. The plurality of source code files are structured in a predefined format. In an embodiment, the predefined format for structuring of the plurality of source code files, wherein the programming language used is Java, is:

Class_Name.java (defines)
<import specified>(form class diagram)
Class_Name {
<attributes list> (form class diagram)
<method list> (form class diagram)
<Method>{
<Pre-Condition >(from state diagram)
<method body>(from sequence diagram)
<post-condition>(from state diagram)
}
};

The predefined format is the well-formedness rules for the source code files.

If the well-formedness rules for the new entity are not verified, the check in of the new entity into repository 614 fails.

At step 904, an entity A stored in repository 614 is selected based on a predefined condition. In an embodiment of the invention, the predefined condition is that in case an entity A is being selected for the first time, MV 820 associated with the entity should have the value 0. On subsequent selections, the value of MV 820 associated with the entity A must be 1 more than the value of MV 820 associated with the previously selected entity.

At step 906, values of a first set of parameters associated with the new entity and values of the first set of parameters associated with the entity A are compared. In an embodiment of the invention, the first set of parameters includes set of defined entities 824, reference 812 and ED 828. Values of set of defined entities 824, reference 812 and ED 828 of the entity A is extracted from repository 614. This is compared with the values of set of defined entities 824, reference 812 and ED 828 of the new entity.

At step 908, a value is assigned to MV 820 associated with the new entity. In case, the value of the first set of parameters associated with the new entity and the value of the first set of parameters associated with the entity A are the same, the value of MV 820 of the entity A is assigned to the value of MV 820 of the new entity. In case, the value of the first set of parameters associated with the new entity and the value of the first set of parameters associated with the entity A are not the same, 1 is added to the value of MV 820 of the entity A and this value is assigned to MV 820 of the new entity.

At step 910, values of a second set of parameters associated with the entity A are compared with the values of the second set of parameters associated with the new entity. In an embodiment of the invention, the second set of parameters includes MV 820 and creation 830. Based on the comparison of the values of the second set of parameters associated with the entity A with the values of the second set of parameters associated with the new entity, a value is assigned to FV 822 of the new entity at step 912. The steps 810 and 812 are explained in further detail in conjunction with FIG. 8.

At step 914, a check is conducted to ensure that steps 804-812 have been performed for all the entities stored in repository 614. In an embodiment of the invention, the check is based on the value of MV 820 associated with the entity A. In case, the value of MV 820 associated with the entity A is the highest among the values of MV 820 associated with all the other entities in repository 614, it indicates that steps 804-812 have been performed for all the other entities stored in repository 614. In case, the value of MV 820 associated with the entity A is not the highest among the values of MV 820 associated with all the other entities in repository 614, it indicates that steps 804-812 have not been performed for all the other entities in repository 614. Thereafter, steps 804-814 are repeated.

At step 916, the new entity is stored in repository 614.

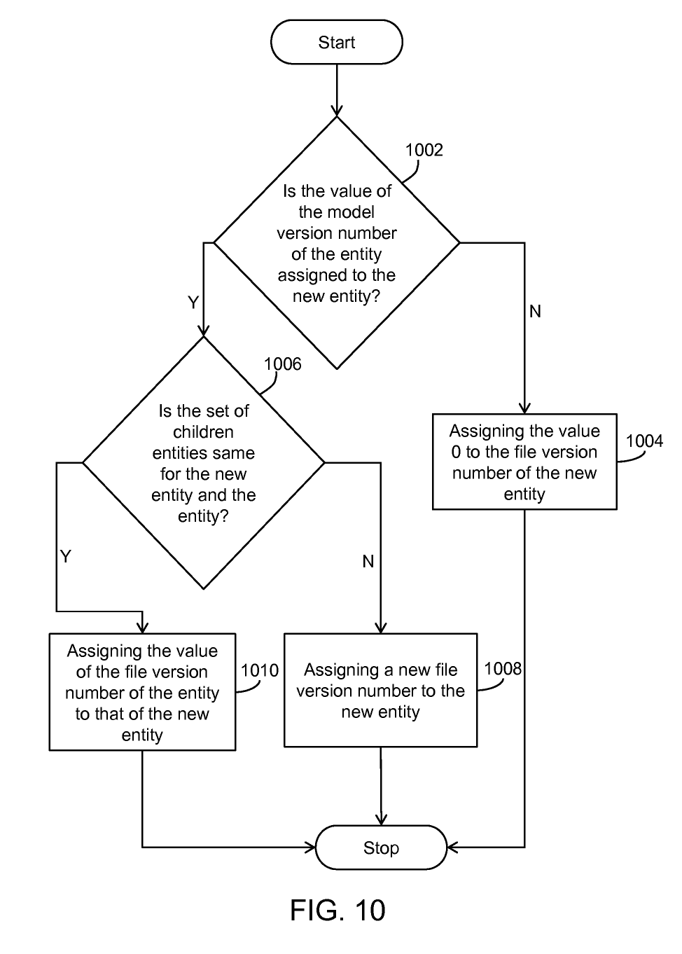

FIG. 10 is a flowchart depicting the steps involved in assignment of a value to the file version number associated with the new entity in accordance with an embodiment of the present invention.

At step 1002, the value of MV 820 of the new entity and the value of MV 820 of the entity A is compared. In case, the value of MV 820 of the new entity and the value of MV 820 of the entity A are not the same, FV 822 of the new entity is assigned the value of 0 at step 1004. In case, the value of MV 820 of the new entity and the value of MV 820 of the entity A are the same, at step 1006, value of creation 830 associated with the new entity and the value of creation 830 associated with the entity A are compared. In case the value of creation 830 associated with the new entity and the value of creation 830 associated with the entity A are not same step 1008 is executed. At step 1008, 1 is added to the value of FV 822 associated with the entity A and this value is assigned to FV 822 associated with the new entity. In case the value of creation 830 associated with the new entity and the value of creation 830 associated with the entity A are the same, at step 1010, the value of FV 822 associated with the entity A is assigned to FV 822 associated with the new entity.

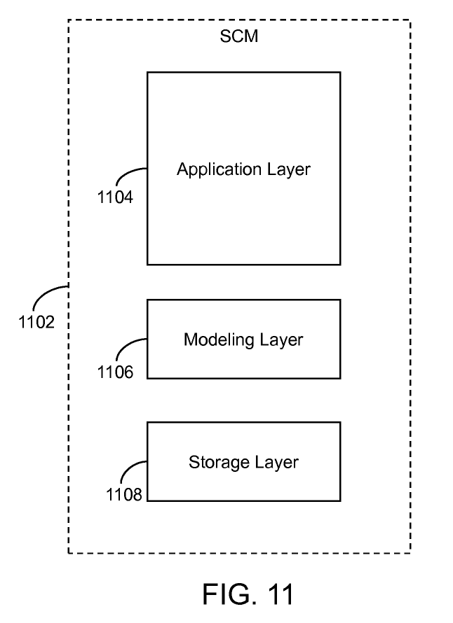

FIG. 11 is a schematic depicting layered model of SCM 1102 for implementing the versioning of entities in accordance with an embodiment of the present invention.

According to an embodiment of the invention, the versioning is implemented by a layered model of SCM 1102 with two version numbers—MV 820 and FV 822. A layered model of SCM 1102 represents a functionality classification. The concepts are represented in three layers according to their functionality and interactions. The three layers are Application layer 1104, Modeling layer 1106 and Storage layer 1108.

Application layer 1104 includes functionalities like creating entity 802, editing the source code and other information. Application layer 1104 can be grouped in three different software configuration management groups which focus on processes like change request, lifecycle contact and context management; development and deployment. Development comprises workspace, transparent view and transaction view. Workspace is an environment where a programmer can work on a task like debugging or software development. Deployment refers to activities like release, installation, deactivation and the likes. Lifecycle applications are applications used for product lifecycle management such as project management tools, bug tracking, release planning and management tools.

Application layer 1104 comprises deployment tools, development applications and the likes. Deployment tools are tools which are used to manage and monitor deployments, such as server deployment, dash boards, update mangers and other deployment management frame works including but not limited to, JMX, MS update frameworks. Development applications are development tools such as UML editor and source code editors, debugging tools and IDEs. The development applications enable users to operate and make changes to the information stored in SCM repository. Furthermore, application layer 1104 also has applications to interact with the SCM repository and construct the deliverable product out of SCM 1102.

Modeling layer 1106 comprises functionality of designing of the software system. Modeling layer 1106 includes the SCM concepts including but not limited to, system modeling, subsystem modeling, Object pool, Change set, Attribution and Consistency maintenance. Modeling layer 1106 allows a user to use the development applications in application layer 1104 to select a model to work on. The model has objects like entity 802 which includes but is not limited to the design entities and the code entities.

Storage layer 1108 manages the entities and versions of entities in storage. The SCM concepts corresponding to storage layer 1108 include but are not limited to, repository and distributed component collectively called storage. In storage layer 1108, derivation procedure for entity 802 is present. The derivation procedure takes the changes made to the set of parameters associated with entity 802 as arguments and derives new versions of entity 802.

According to another embodiment of the invention, all the versioning complexity is handled in modeling layer 1106. Versioning is done for each design entity and code entity including but not limited to, method sequence diagram 312, class diagram 314, use case 326 and the likes.

This meets the objective of determining compatibility between a plurality of entities during the course of software development by assigning two version numbers to the entities—a model version number which determines compatibility at the design level and a file version number which determined compatibility at the source code level.

While examples embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method of versioning a new entity of a software system during software development, the software system comprising one or more entities, the entities being stored in a repository, each entity being associated with a set of parameters, the set of parameters comprising a model version number and a file version number, the method comprising the steps of:
(a) receiving a new entity for check-in into the repository, the new entity being associated with the set of parameters;
(b) selecting an entity from the repository based on a condition;
(c) comparing the values of a first set of parameters associated with the new entity with the values of the first set of parameters associated with the entity, the first set of parameters being a subset of the set of parameters;
(d) based on the comparison of the values of the first set of parameters, assigning a value to the model version number associated with the new entity;
(e) comparing the values of a second set of parameters associated with the new entity with the values of the second set of parameters associated with the entity, the second set of parameters being a subset of the set of parameters;
(f) based on the comparison of the values of the second set of parameters, assigning a value to the file version number associated with the new entity;
(g) repeating steps (b)-(f) for all the entities stored in the repository; and,
(h) storing the new entity in the repository.

2. The method of claim 1 wherein the entity is one of a design entity and a code entity.

3. The method of claim 2 wherein the design entity is selected from a group consisting of a development perspective diagram; a deployment perspective diagram; and, a requirements perspective diagram.

4. The method of claim 2 wherein the code entity is a source perspective diagram.

5. The method of claim 1 wherein the step of check-in is done based on the verification of one or more predefined rules associated with the new entity.

6. The method of claim 1 wherein the set of parameters further comprise name, type, ID, set of defined entities, set of referred entities, set of external definition from imports and set of children entities associated with the new entity.

7. The method of claim 1 wherein the first set of parameters comprises defined entities and referred entities.

8. The method of claim 1 wherein the second set of parameters comprises the model version number and the set of children entities.

9. A computer-readable storage medium encoded with program instructions for versioning a new entity of a software system during software development, the software system comprising one or more entities, the entities being stored in a repository, each entity being associated with a set of parameters, the set of parameters comprising a model version number and a file version number, the program instructions when executed by one or more processors causes the one or more processors to perform the steps of:
(a) receiving a new entity for check-in into the repository, the new entity being associated with the set of parameters;
(b) selecting an entity from the repository based on a condition;
(c) comparing the values of a first set of parameters associated with the new entity with the values of the first set of parameters associated with the entity, the first set of parameters being a subset of the set of parameters;
(d) based on the comparison of the values of the first set of parameters, assigning a value to the model version number associated with the new entity;
(e) comparing the values of a second set of parameters associated with the new entity with the values of the second set of parameters associated with the entity, the second set of parameters being a subset of the set of parameters;
(f) based on the comparison of the values of the second set of parameters, assigning a value to the file version number associated with the new entity;
(g) repeating steps (b)-(f) for all the entities stored in the repository; and,
(h) storing the new entity in the repository.

10. The computer readable-storage medium of claim 9, wherein the entity is one of a design entity and a code entity.

11. The computer readable-storage medium of claim 10, wherein the design entity is at least one of a development perspective diagram, a deployment perspective diagram and a requirements perspective diagram.

12. The computer readable-storage medium of claim 10, wherein the code entity is a source perspective diagram.

13. The computer readable-storage medium of claim 9, wherein the step of check-in is done based on the verification of at least one predefined rule associated with the new entity.

14. The computer readable-storage medium of claim 9, wherein the set of parameters further comprise name, type, ID, set of defined entities, set of referred entities, set of external definition from imports and set of children entities associated with the new entity.

15. The computer readable-storage medium of claim 9, wherein the first set of parameters comprises defined entities and referred entities.

16. The computer readable-storage medium of claim 9, wherein the second set of parameters comprises the model version number and the set of children entities.

17. A system for versioning a new entity of a software system during software development, the software system comprising at least one entity, each entity being associated with a set of parameters, the set of parameters comprising a model version number and a file version number, the system comprising:
(a) a user interface for receiving a new entity, the new entity being associated with the set of parameters;
(b) a repository, the repository storing the entities;
(c) a selection module, the selection module configured to select an entity from the repository based on a condition;
(d) a model versioning module, the model versioning module configured to:
(1) compare the values of a first set of parameters associated with the new entity with the values of the first set of parameters associated with the entity selected by the selection module, the first set of parameters being a subset of the set of parameters;
(2) based on the comparison of the values of the first set of parameters, assign a value to the model version number associated with the new entity; and,
(e) a file versioning module, the file versioning module configured to:
(1) compare the values of a second set of parameters associated with the new entity with the values of the second set of parameters associated with the entity selected by the selection, the second set of parameters being a subset of the set of parameters; and,
(2) based on the comparison of the values of the second set of parameters, assign a value to the file version number associated with the new entity.

18. The system of claim 17 wherein the set of parameters further comprise name, type, ID, set of defined entities, set of referred entities, set of external definition from imports, and set of children entities associated with the new entity.

19. The system of claim 17 wherein the first set of parameters comprises defined entities and referred entities.

20. The system of claim 17 wherein the second set of parameters comprises the model version number and the set of children entities.
